(19) United States
(12) Patent Application Publication
(10) Pub. No.: US 2014/0233680 A1
(43) Pub. Date: Aug. 21, 2014

(54) MAP DECODER HAVING LOW LATENCY AND OPERATION METHOD OF THE SAME

(71) Applicant: Electronics and Telecommunications Research Institute, Daejeon (KR)

(72) Inventors: Yong Ho LEE, Ulsan (KR); Deock Gil OH, Daejeon (KR)

(73) Assignee: Electronics and Telecommunications Research Institute, Daejeon (KR)

(21) Appl. No.: 14/187,128

(22) Filed: Feb. 21, 2014

(30) Foreign Application Priority Data
Feb. 21, 2013 (KR) 10-2013-0018387

(51) Int. Cl. H04L 1/00

(52) U.S. Cl. CPC H04L 1/0055
USPC 375/340

(57) ABSTRACT

Provided is a maximum a posteriori (MAP) decoder having a low latency and an operation method of the MAP decoder, including a branch metric calculation block to calculate a branch metric based on a received signal, a processor control block to demultiplex a received signal in a certain trellis section, an Extrinsec vector, and the calculated branch metric value, and a processor to calculate a path metric entering each state node in a certain trellis section, compensate for the calculated path metric, and calculate a state metric to be applied to a next trellis section based on the compensated path metric.

### CROSS-REFERENCE TO RELATED APPLICATION

This application claims the priority benefit of Korean Patent Application No. 10-2013-0018387, filed on Feb. 21, 2013, in the Korean Intellectual Property Office, the disclosure of which is incorporated herein by reference.

### BACKGROUND

1. Field of the Invention

The present invention relates to detection technology of a communication system, and more particularly to a technical idea of reducing an output latency and maintaining a performance identical to an existing maximum a posteriori (MAP) decoder by performing a parallel calculation based on recursion initialized to an arbitrary value for a recursive calculation used when detecting a received signal in a MAP decoder and performing compensation afterwards.

2. Description of the Related Art

A maximum likelihood receiver is widely known as an optimum method of detecting a received signal in a case of long distance communication.

However, a practical realization of the receiver may be challenging because of a non-linear increase in hardware complexity and calculation that may occur when a plurality of bits is allocated to a symbol for a length of a transmission sequence and a highly-efficient transmission.

A maximum a posteriori (MAP) decoder, in particular, may have an issue of complexity because it is necessary for the MAP decoder to calculate all the metrics of paths connected to each state node in each trellis section, and the calculation is processed bidirectionally, for example, forward and backward.

Moreover, the calculation of all the metrics of the paths is performed based on a recursive calculation and thus, a latency issue may arise. A severity of the latency issue may increase as the length of the transmission sequence increases.

### SUMMARY

According to an aspect of the present invention, there is provided a maximum a posteriori (MAP) decoder including a branch metric calculation block to calculate a branch metric based on a received signal, a processor control block to demultiplex a received signal in a certain trellis section, an Extrinsec vector, and a value of the calculated branch metric, a processor to calculate a path metric entering each state node in the certain trellis section, compensate for the calculated path metric, and calculate a state metric to be applied to a next trellis section based on the compensated path metric.

The processor may include an arbitrary recursive calculation block to calculate the path metric, a compensation block to compensate for the calculated path metric, and an addition/comparison block to calculate the state metric to be applied to the next trellis section.

The arbitrary recursive calculation block may calculate the path metric based on a recursive calculation initialized to an arbitrary value.

The arbitrary recursive calculation block may receive the arbitrary value delivered from the processor control block or set a different arbitrary value for each state node.

The compensation block may compensate for the calculated path metric based on an actual state metric calculated in a previous trellis section.

The addition/comparison block may calculate the state metric to be applied to the next trellis section based on the compensated path metric.

The MAP decoder may further include a state metric table storage block to store the calculated state metric.

The MAP decoder may further include a branch metric table storage block to store branch metrics corresponding to all trellis sections.

The MAP decoder may further include a log-likelihood ratio (LLR) calculation block to calculate an LLR with respect to a received signal based on the state metric and the branch metric and output a vector of the calculated LLR.

According to another aspect of the present invention, there is provided an operation method of an MAP decoder including calculating, by a branch metric calculation block, a branch metric based on a received signal, demultiplexing, by a processor control block, a received signal in a certain trellis section, an Extrinsec vector, and the calculated branch metric, calculating, by a processor, a path metric entering each state node in a certain trellis section based on an arbitrary recursive calculation, compensating, by the processor, for the calculated path metric, and calculating, by the processor, a state metric to be applied to a next trellis based on the compensated path metric.

The operation method of the MAP decoder may further include storing the calculated state metric in a state metric table storage block.

The operation method of the MAP decoder may further include storing branch metrics corresponding to all trellis sections in a branch metric table storage block.

The operation method of the MAP decoder may further include calculating, by an LLR calculation block, an LLR with respect to a received signal based on the branch metric and the branch metric and outputting the calculated vector of the LLR.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a flow of a one-way calculation of a maximum a posteriori (MAP) decoder according to a related art.

FIG. 2 is a block diagram illustrating a maximum a posteriori (MAP) decoder according to an embodiment of the present invention.

FIG. 3 is a block diagram illustrating a processor according to an embodiment of the present invention.

FIG. 4 is a diagram illustrating a flow of a calculation of a maximum a posteriori (MAP) decoder according to an embodiment of the present invention.

FIG. 5 is a flowchart illustrating an operation method of a maximum a posteriori (MAP) decoder according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying figures, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

According to an embodiment of the present invention, a recursive calculation used to detect a received signal in a maximum a posteriori (MAP) decoder may be performed by a parallel calculation based on recursion initialized to an arbitrary value and compensation may be performed afterwards and thus, performances identical to those of an existing MAP decoder may be maintained and output latency may be reduced.

An existing MAP decoder may perform a calculation associated with a next trellis section only after a calculation associated with a trellis is completed. However, a MAP decoder according to an embodiment of the present invention may perform, in parallel, the calculations associated with a plurality of connected trellis sections.

Also, the MAP decoder may be applicable to forward-backward calculations and to a max-log MAP decoder.

In order to have a maximum log-likelihood when detecting a received signal, the MAP decoder may perform a detection calculation with respect to the received signal bidrectionally, for example, forward and backward.

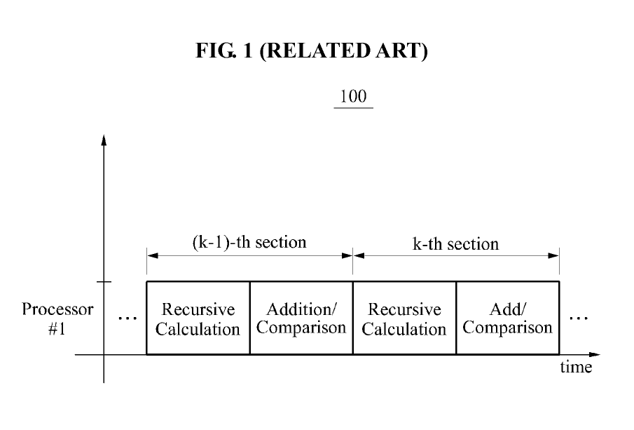

FIG. 1 is a diagram illustrating a flow 100 of a one-way calculation of an MAP decoder according to a related art.

For a better understanding, only a flow of a one-way calculation, of forward and backward calculations, of a MAP decoder is illustrated herein.

A calculation of a branch metric corresponding to each trellis section may be designed to be performed prior to or concurrent with a detection calculation according to an intention of a design engineer.

According to an embodiment of the present invention, the calculation may be applicable in both ways. However, for a better understanding, descriptions herein are based on a model in which the calculation of the branch metric is completed prior to the detection calculation.

A typical MAP decoder may perform detection of a received signal based on two internal operations.

In forward and backward calculations for detection, the two internal operations may include calculating metrics of paths connected to each state node based on a recursive calculation in each trellis section, and applying a result of adding and comparing the path metrics associated with each state node to a calculation of a next trellis section.

Related equations are shown below. As used equations hereinafter, y denotes a received signal vector, k denotes a k-th trellis section, S′ denotes a previous state node, S denotes a current state node, and N denotes a symbol length.

<MAP Decoder>

Joint Probability:P(S′,S,y)=αₖ₋₁(S′)γₖ(S′,S)βₖ(S)

Forward:

$${α}_{k} ( S ) = {\sum }_{{S}^{′}} {α}_{k - 1} ( {S}^{′} ) {γ}_{k} ( {S}^{′} , S ) , {α}_{0} ( s ) = \{ \begin{matrix}1 & s = 0 \\ 0 & s \neq 0\end{matrix}$$

Backward:

$${β}_{k - 1} ( {S}^{′} ) = {\sum }_{S} {β}_{k} ( S ) {γ}_{k} ( {S}^{′} , S ) , {β}_{N} ( s ) = \{ \begin{matrix}1 & s = 0 \\ 0 & s \neq 0\end{matrix}$$

<Max-Log MAP Decoder>

Joint Probability: Ir(P(S′,S,y))=Aₖ₋₁(S′)+Γₖ(S′,S)+Bₖ(S)

Branch Metric: Γₖ(S′,S)=Ir(γₖ(S′,S))

Forward:

$${A}_{k} ( S ) = {max}_{{S}^{′}} [ {a}_{k} ( {S}^{′} , S ) ] = {max}_{{S}^{′}} [ {a}_{k - 1 , log} ( {S}^{′} ) + {Γ}_{k} ( {S}^{′} , S ) ] , \\ {α}_{k - 1 , log} ( {S}^{′} ) = ln ( {α}_{k - 1} ( {S}^{′} ) )$$

Backward:

$${B}_{k - 1} ( {S}^{′} ) = {max}_{S} [ {b}_{k - 1} ( {S}^{′} , S ) ] = {max}_{S} [ {B}_{k , log} ( S ) + {Γ}_{k} ( {S}^{′} , S ) ] , \\ {β}_{k , log} ( S ) = ln ( {β}_{k} ( S ) )$$

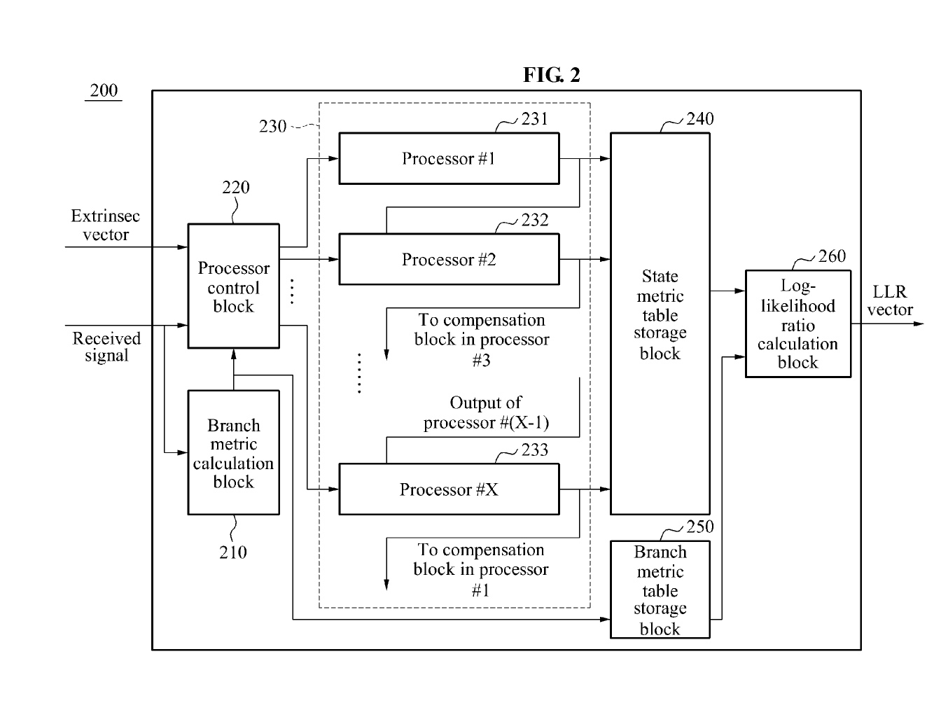

FIG. 2 is a block diagram illustrating a maximum a posteriori (MAP) decoder 200 according to an embodiment of the present invention.

The MAP decoder 200 may include, based on a function, a processor control block 220, a branch metric calculation block 210, an arbitrary recursive calculation block, a compensation block (not shown), an addition/comparison block (not shown), a state metric table storage block 240, a branch metric table storage block 250, and a log-likelihood ratio (LLR) calculation block 260.

The MAP decoder 200 may include the branch metric calculation block 210, the processor control block 220, and a processor 230.

The branch metric calculation block 210 may calculate a branch metric based on a received signal.

The branch metric calculation block 210 may calculate the branch metric based on the received signal and deliver the calculated value to the processor control block 220 and the branch metric table storage block 250.

The processor control block 220 may demultiplex a received signal in a certain trellis section, an Extrinsec vector, and the calculated branch metric value.

The processor control block 220 may receive inputs of the received signal, the Entrinsec vector, and the branch metric value delivered from the branch metric calculation block 210, and demultiplex the received signal in the certain trellis section in which each processor operates, the Extrinsec vector, and the branch metric value to be delivered.

Although a sequence of operations may be adjusted according to an intention of a design engineer, operations are described herein to occur in sequence.

The processor 230 may include processors 231, 232, and 233, which differ from one another.

The processor 230 may calculate, based on an arbitrary recursive calculation, a path metric entering each state node in a certain trellis section, compensate for the calculated path metric, and calculate, using the compensated path metric, a state metric to be applied to a next trellis section.

The MAP decoder 200 may further include the state metric table storage block 240 to store the calculated state metric.

The state metric table storage block 240 may store a state metric obtained as a result of a forward calculation and a backward calculation, and deliver the state metric to the LLR calculation block 260 to calculate an LLR of a received signal.

The MAP decoder 200 may further include the branch metric table storage block 250 to store branch metrics corresponding to all trellis sections.

The branch metric table storage block 250 may store the branch metrics corresponding to all trellis sections and deliver the branch metrics to the LLR calculation block 260 to calculate an LLR of a received signal.

The MAP decoder 200 may further include the LLR calculation block 260 to calculate an LLR with respect to the received signal based on a state metric and a branch metric and output a vector of the calculated LLR.

The LLR calculation block 260 may calculate an LLR with respect to the received signal based on the state metric delivered from the state metric table storage block 240 and the branch metric delivered from the branch metric table storage block 250, and output a vector of the LLR. Also, the outputted vector of the LLR may be subject to a hard decision or be delivered to a channel decoder.

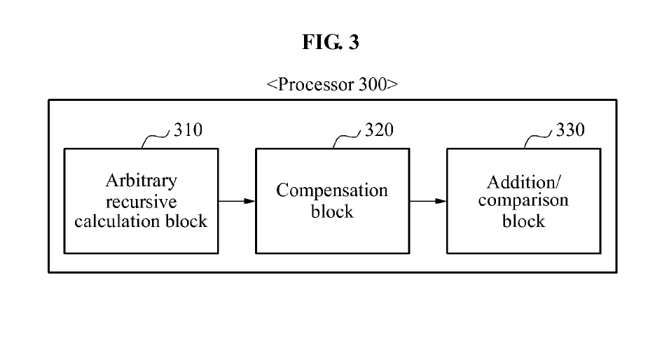

FIG. 3 is a block diagram illustrating a processor 300 according to an embodiment of the present invention.

The processor 300 may include an arbitrary recursive calculation block 310, a compensation block 320, and an addition/comparison block 330.

The arbitrary recursive calculation block 310 may calculate a path metric based on a recursive calculation initialized to an arbitrary value.

The arbitrary recursive calculation block 310 may receive an arbitrary value delivered from a processor control block, or set a different arbitrary value for each state node.

The arbitrary recursive calculation block 310 may calculate metrics of paths entering each state node in a certain trellis section in which each processor operates.

An existing MAP decoder may perform a recursive calculation based on a state metric calculated in a previous trellis section. However, according to an embodiment of the present invention, the arbitrary recursive calculation block 310 may perform a recursive calculation initialized to an arbitrary value.

Thus, a parallel processing for a plurality of connected trellis sections may be possible in the multi-processors.

The arbitrary recursive calculation block 310 may perform the recursive calculation shown below by initializing an arbitrary value to be v.

According to an intention of a design engineer, the arbitrary value v may be delivered from the processor control block, or a calculation may be performed by setting a different arbitrary value for each state node.

For convenience, a case in which a calculation is performed by setting an identical value for each node is described herein.

<MAP Decoder>

Forward:

$${α}_{k , arb} ( S ) = {\sum }_{{S}^{′}} v \cdot {γ}_{k} ( {S}^{′} , S ) = v \cdot {\sum }_{{S}^{′}} {γ}_{k} ( {S}^{′} , S ) , {α}_{0} ( s ) = \{ \begin{matrix}1 & s = 0 \\ 0 & s \neq 0\end{matrix}$$

Backward:

$${α}_{k - 1 , arb} ( {S}^{′} ) = {\sum }_{S} v \cdot {γ}_{k} ( {S}^{′} , S ) = v \cdot {\sum }_{S} {γ}_{k} ( {S}^{′} , S ) , {β}_{N} ( s ) = \{ \begin{matrix}1 & s = 0 \\ 0 & s \neq 0\end{matrix}$$

<Max-Log MAP Decoder>

Forward: a_{k,arb}(S′,S)=v+Γₖ(S′,S)

Backward: b_{k-t,arb}(S′,S)=v+Γₖ(S′,S)

The compensation block 320 may compensate for the calculated path metric.

More particularly, the compensation block 320 may compensate for the calculated path metric based on an actual state metric calculated in a previous trellis section.

The compensation block 320 may compensate for the path metric obtained by initializing to an arbitrary value.

The compensation block 320 may compensate for the path metric obtained based on the actual state metric calculated in the previous trellis section, not on an arbitrary value and thus, the MAP decoder may have an output value identical to an existing MAP decoder.

The compensation block 320 may receive the actual state metric delivered from the processor operating based on the previous trellis section.

<MAP Decoder>

Forward:

$${α}_{k} ( S ) = {α}_{k , arb} ( S ) - {\sum }_{{S}^{′}} ( v - {α}_{k - 1} ( {S}^{′} ) ) \cdot {γ}_{k} ( {S}^{′} , S )$$

Backward:

$${β}_{k - 1} ( {S}^{′} ) = {β}_{k - 1 , arb} ( {S}^{′} ) - {\sum }_{S} ( v - {β}_{k } ( S ) ) \cdot {γ}_{k} ( {S}^{′} , S )$$

<Max-Log MAP Decoder>

Forward: aₖ(S′,S)=a_{k,arb}(S′,S)−(v−Aₖ₋₁(S′))

Backward: bₖ₋₁(S′,S)−b_{k-1,arb}(S′,S)−(v−Bₖ(S))

The addition/comparison block 330 may calculate a state metric to be applied to a next trellis section.

In particular, the addition/comparison block 330 may add all the compensated path metrics or exclusively apply a maximum value of the compensated path metrics to the state metric of a calculation of the next trellis section.

The addition/comparison block 330 may calculate the state metric to be applied to the calculation of the next trellis section, using path metrics entering each state node in a certain trellis section in which each processor operates.

A typical MAP decoder may add all the path metrics entering each state node and apply the resulting value to the state metric in the next trellis section. A max-log MAP decoder may exclusively apply a maximum value of the path metrics entering each state node to the state metric in the next trellis section.

The calculated next state metric may be delivered to the compensation block of the processor calculating the next trellis section and to the state metric table storage block.

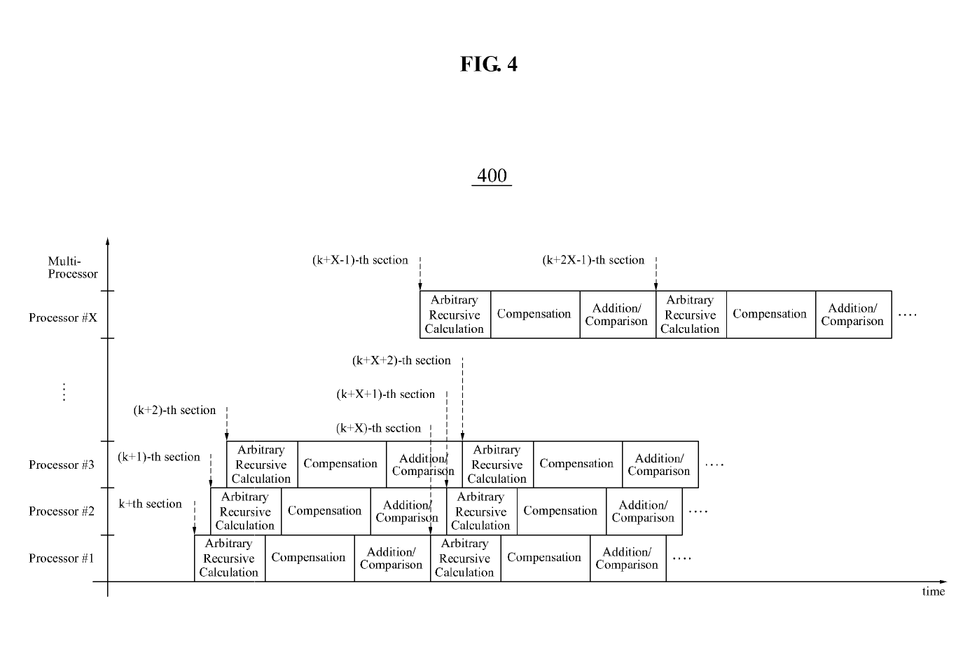

FIG. 4 is a diagram illustrating a flow of calculation of a maximum a posteriori (MAP) decoder according to an embodiment of the present invention.

As shown in FIG. 4, calculations and operations of a processor control block and each processor are a core part, and calculations and operations of the rest, such as, a state metric table storage block, a branch metric table storage block, and an LLR calculation block may use a typical method, not be limited to a certain method.

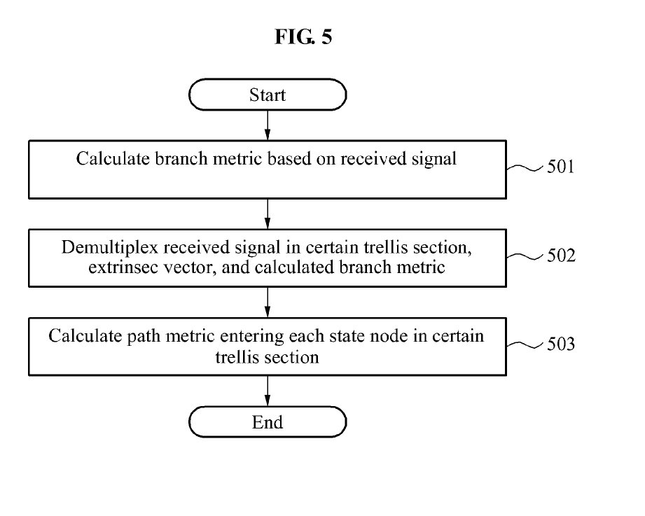

FIG. 5 is a flowchart illustrating an operation method of a maximum a posteriori (MAP) decoder according to an embodiment of the present invention.

In operation 501, a branch metric calculation block may calculate a branch metric based on a received signal.

In operation 502, a processor control block may demultiplex a received signal in a certain trellis section, an Extrinsec vector, and the calculated branch metric.

In operation 503, a processor may calculate a path metric entering each state node in the certain trellis section based on an arbitrary recursive calculation, compensate for the calculated path metric, and calculate a state metric to be applied to a next trellis section based on the compensated path metric.

The operation method of the MAP decoder may include storing the calculated state metric in a state metric table storage block.

Also, the operation method of the MAP decoder may include storing branch metrics corresponding to all trellis sections in a branch metric table storage block.

Further, the operation method of the MAP decoder may include calculating, by an LLR calculation block, an LLR with respect to a received signal based on a state metric and a branch metric and outputting a vector of the calculated LLR.

According to an embodiment of the present invention, the MAP decoder may reduce an output latency and maintain a performance identical to an existing MAP decoder.

According to another embodiment of the present invention, the MAP decoder may be applicable to both forward and backward calculations, not be limited to a one-way calculation, and applicable to a max-long MAP decoder.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A maximum a posteriori (MAP) decoder, comprising:
a branch metric calculation block to calculate a branch metric based on a received signal;
a processor control block to demultiplex a received signal in a certain trellis section, an Extrinsec vector, and a value of the calculated branch metric; and
a processor to calculate a path metric entering each state node in the certain trellis section based on an arbitrary recursive calculation, compensate for the calculated path metric, and calculate a state metric to be applied to a next trellis section based on the compensated the path metric.

2. The MAP decoder of claim 1, wherein the processor comprises:
an arbitrary recursive calculation block to calculate the path metric based on the arbitrary recursive calculation;
a compensation block to compensate for the calculated path metric; and
an addition/comparison block to calculate the state metric to be applied to the next trellis section.

3. The MAP decoder of claim 2, wherein the arbitrary recursive calculation block calculates the path metric based on a recursive calculation initialized to an arbitrary value.

4. The MAP decoder of claim 3, wherein the arbitrary recursive calculation block receives the arbitrary value delivered from the processor control block or sets a different arbitrary value for each state node.

5. The MAP decoder of claim 2, wherein the compensation block compensates for the calculated path metric based on an actual state metric calculated in a previous trellis section.

6. The MAP decoder of claim 2, wherein the addition/comparison block adds all compensated path metrics or applies a maximum value of the all compensated path metrics exclusively to the state metric in the next trellis section.

7. The MAP decoder of claim 1, further comprising:
a state metric table storage block to store the calculated state metric.

8. The MAP decoder of claim 1, further comprising:
a branch metric table storage block to store branch metrics corresponding to all trellis sections.

9. The MAP decoder of claim 1, further comprising:
a log-likelihood ratio (LLR) calculation block to calculate an LLR of the received signal based on the state metric and the branch metric and output a vector of the calculated LLR.

10. An operation method of a maximum a posteriori (MAP) decoder, the method comprising:
calculating, by a branch metric calculation block, a branch metric based on a received signal;
demultiplexing, by a processor control block, a received signal in a certain trellis section, an Extrinsec vector, and the calculated branch metric;
calculating, by a processor, a path metric entering each state node in the certain trellis section based on an arbitrary recursive calculation;
compensating, by the processor, for the calculated path metric; and
calculating, by the processor, a state metric to be applied to a next trellis section, based on the compensated path metric.

11. The method of claim 10, further comprising:
storing, by a state metric table storage block, the calculated state metric.

12. The method of claim 10, further comprising:
storing branch metrics corresponding to all trellis sections in a branch metric table storage block.

13. The method of claim 10, further comprising:
calculating, by a log-likelihood ratio (LLR) calculation block, an LLR of the received signal based on the state metric and the branch metric, and outputting a vector of the calculated LLR.
